(19) United States
(12) Patent Application Publication
(10) Pub. No.: US 2012/0253594 A1
(43) Pub. Date: Oct. 4, 2012

(54) Operating System For A Motor Vehicle

(76) Inventor: Michael Schreiber, Immesheim (DE)

(21) Appl. No.: 13/130,864

(22) PCT Filed: Nov. 20, 2009
(86) PCT No.: PCT/EP2009/065573

§ 371 Date: May 24, 2011

(30) Foreign Application Priority Data
Nov. 28, 2008 (DE) 1020080441740

(51) Int. Cl. G06F 17/00; G06K 7/01

(52) U.S. Cl. 701/36

(57) ABSTRACT

A control system for a motor vehicle includes at least one command unit, which controls an associated vehicle function, and/or at least one sensor which senses a vehicle parameter. The control system also includes a control unit and a plurality of display devices. The information displayed by the display devices is controlled as a function of actuation of the command unit and/or the parameter sensor. The control unit controls the display device by means of an RFID reader which forms a data exchange connection with an RFID transponder which is connected to each display device.

### FIELD OF THE INVENTION

The present disclosure relates to a control system for a vehicle.

### BACKGROUND OF THE INVENTION

A microprocessor-based vehicle control system is known, for example, by the designation “CommandCenter” in John Deere Tractors of the 7030 Premium series. The control system comprises a plurality of command units which are mounted on a side console of a driver's cab and are provided for manually operating different vehicle functions. Furthermore, a display device which is pivotably mounted on the side console is provided in the form of a touch-sensitive flat screen which displays the settings or operating actions which are performed by means of the command units as well as additional operation-related information and/or parameters of the tractor in a figurative and/or alphanumeric fashion.

The display device is interlinked to the microprocessor controller of the control system by means of a CAN data bus which is fixedly routed in the tractor. The location at which the display device is mounted cannot be freely selected owing to the fixed routing of the CAN data bus.

### SUMMARY

According to an aspect of the present disclosure, a control system is provided which allows a wide degree of freedom with respect to the location at which a display device is mounted.

The control system for a motor vehicle includes at least one command unit for operating an associated vehicle function, and/or at least one sensor unit for sensing a vehicle operating parameter. Furthermore, display devices are actuated as a function of activation of the command unit and/or of the vehicle parameter so that the display devices display content which is assigned to the vehicle function to be operated and/or the vehicle parameter is displayed by the display devices. To actuate the display devices, the control unit establishes, by means of an RFID reading unit, a data exchange connection to one of a plurality of RFID transponders, each of which interacts with a corresponding one of the display devices. RFID (RFID—Radio frequency Identification) is a system for wireless transmission of data between a data carrier, referred to as the RFID transponder or RFID tag, and an RFID reading unit.

Each RFID transponder typically has an antenna in the form of a coil, an analog high frequency circuit for calling data stored in a data memory and a data processing unit between the data memory and the analog high frequency circuit. The data memory can, in particular, be written to repeatedly (read/write memory) with the result that its memory content can also be subsequently changed and/or adapted. Alternatively, it is also conceivable to use a data memory which can be written to once (read only memory). In order to establish a data exchange connection to the RFID transponder, the RFID reading unit generates an electromagnetic field which is received by the antenna coil of the RFID transponder. As a result, the data memory which is contained in the RFID transponder is activated, with the result that encoded instructions can be read in and out by means of the RFID reading unit via the antenna of the RFID transponder. The RFID transponder does not irradiate a separate electromagnetic field but rather modulates that of the RFID reading unit. The electromagnetic field of the RFID reading unit has a range from a centimeter up to thirty meters or more depending on the frequency used and power.

Owing to the wireless connection between the display device and the RFID transponders, the display device can be mounted at virtually any desired location in the motor vehicle. In particular, the display device is not tied to interlinking with a CAN data bus which is fixedly routed in the motor vehicle. There is therefore a large degree of freedom with respect to the mounting of the display device in the motor vehicle.

The motor vehicle is an agricultural utility vehicle, for example a tractor, a harvesting machine, a field chopper or a spraying machine. However, the use of the operating machine according to the invention is not restricted to a certain type of vehicle and/or purpose of use.

The display contents can relate to any functions or vehicle states to be operated, such as occur when the motor vehicle or accessories or attachments which can be attached thereto are operating. The accessories or attachments may be, for example, a front loader which can be attached to a tractor, a sowing machine, a baling press or the like.

The information or content which is to be displayed on the display device is preferably stored in a data memory which is assigned to the RFID transponder. In particular, a plurality of contents can be stored in the data memory in accordance with different vehicle functions to be operated and/or operationally occurring vehicle states. Each display content is unambiguously assigned an identification feature, in the form of a numerical code, which can be selected by means of the RFID reading unit. By selecting a specific identification feature, the associated display content is called from the data memory and subsequently fed to a display driver for the purpose of displaying on the display device.

In other words the control unit determines an identification feature, in the form of an associated numerical code, which is assigned to activation of the at least one command unit and/or of the vehicle parameter. This numerical code is transmitted wirelessly as an encoded instruction to one or more RFID transponders mounted in a spatially distributed fashion in the motor vehicle, by means of the RFID reading unit. Each of the RFID transponders checks whether a display content which corresponds the read-in numerical code is stored in the data memory. If this is the case, the corresponding display content is displayed by suitably actuating the display driver on the respective display device.

It is also conceivable to carry out a self-activated configuration process in which, after initiation of the control system—for example when the motor vehicle is excited—the control unit reads the available display contents sequentially from the data memories of the RFID transponders by means of the RFID reading unit and adapts the operating scope or display scope of the control system in accordance with the display contents stored in the data memories. This is advantageous, in particular in the case of modular operating concepts, in the sense of the implementation of what is referred to as a plug-and-play function in which a functional extension or functional modification is carried out by adding or exchanging individual command units or entire command unit assemblies.

The display contents stored in the data memory may be a component of a menu-based user interface for controlling a multiplicity of vehicle functions. Such user interfaces comprise a hierarchically organized menu structure with a plurality of operating levels, wherein each of the operating levels comprises one or more menu entries corresponding to associated vehicle functions to be operated and/or operationally occurring vehicle states. It is conceivable in this context that, after a specific menu level has been called, all the menu entries included therein, or else only a number of selected menu entries, are displayed on the display device.

In the simplest case, the command unit is a push button key, a rocker switch, a sliding controller or the like. The command unit, can, however, also be designed to operate a multiplicity of vehicle functions. The use of a multifunctional command unit with a plurality of degrees of freedom of adjustment or activation is conceivable here. Said command unit can be designed, in particular to operate a menu-based user interface, as what is referred to as a turn and push signal generator, wherein by rotating the command unit it is possible to navigate in the hierarchically organized menu structure and select a specific menu entry by pressing. Alternatively, the multi-functional command unit can be a joystick, wherein the joystick can have further command units in the form of push button keys or a rocker switch for controlling additional vehicle functions.

In addition, the driver can predefine the vehicle function which is to be operated by the command unit. In this case, frequently used vehicle functions can be assigned to a specific command unit and called immediately when required. The command unit may be arranged in a direct spatial relationship with the display device, for example as what is referred to as a favorite key in the edge region of the display device.

The RFID transponder is preferably integrated structurally into the display device as an integrated CMOS (complementary metal oxide semiconductor) circuit. The antenna can be printed on in the region of the rear side of the display device in the form of a helix.

In particular it is possible to embody the display device as a foil-like, preferably flexible display element. Such a display element can be found, for example, in DE 10 2005 031 448 A1. The latter describes an activatable optical layer which is arranged between an upper and lower electrode layer, and has a multiplicity of liquid crystal bubbles with a diameter of 0.1 □m to 40 □m which are integrated into a polymer matrix. The polymer matrix can comprise, for example, polymerized monomers with a layer thickness of 5 □m to 40 □m. The liquid crystals are oriented in an electrical field which is generated between the upper and lower electrode layers by applying a corresponding control voltage. The optical layer which can be activated can be embodied, in particular, so that it has regions which permit figurative and/or alphanumeric display contents to be displayed. In this case, the RFID transponder is integrated structurally into the polymer matrix of the film-like display element as an organic (polymer) CMOS circuit.

A transparent or semi-transparent design of the film-like display element is also conceivable so that the latter can be attached to a windscreen of the motor vehicle permitting through-light display of the display contents to be displayed in the driver's primary field of vision.

The film-like display element can have an adhesive surface for attachment to a surface of the at least one command unit and/or of a trim element of the motor vehicle. In this case, the display element can also easily subsequently be attached in the motor vehicle.

The display device is preferably supplied with electrical energy by means of the RFID transponder, with the result that the use of a separate electrical energy source can be dispensed with.

In this context, a distinction is basically made between passive and active RFID transponders. Passive RFID transponders do not have a separate power supply and obtain the electrical energy necessary for operation from an induction current which is generated in the antenna coil. The induction current can either be generated by the radiation of the antenna coil by means of the electromagnetic field of the RFID reading unit or else by use of a separate electromagnetic radiation source. On the other hand, active RFID transponders draw their electrical energy from a separate power supply, for example an accumulator, a battery, a super capacitor, a photoelectric element (solar cell) or the like.

In the present case, a passive design of the RFID transponder is preferred, since this permits the display contents to be displayed in a chronologically unlimited way and independently of the light conditions by using the electromagnetic field which is irradiated by means of the RFID reading unit.

### BRIEF DESCRIPTION OF THE DRAWINGS

FIG. 1 is a perspective view of a command unit for use with a control system according to the invention;

FIG. 2 is a schematic diagram of the control system according to the invention; and

FIG. 3 is a schematic diagram of the RFID transponder units of FIG. 2.

### DETAILED DESCRIPTION OF THE DRAWINGS

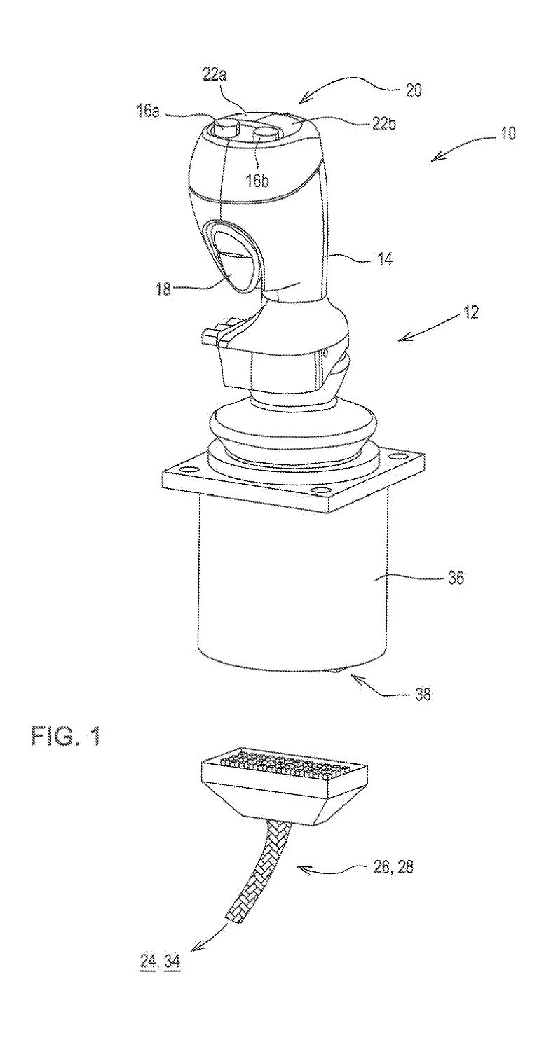

Referring to FIG. 1, a control system 10 includes a multifunctional command unit 12 which can be manipulated by a vehicle driver/operator in a plurality of degrees of freedom of adjustment or activation so that the operator can control a multiplicity of associated vehicle functions. The command unit 12 can be mounted in an operating console or side console of a tractor (not shown). The command unit 12 has a primary command element which is a pivoting joystick 14, and secondary command elements. The secondary command elements may include a plurality of push buttons arranged on the upper side of the joystick 14 (represented by keys 16a and 16b), and/or a rocker switch 18 on the gripping circumference of the joystick 14. The command elements 14, 16a and 16b and 18 are of a conventional design and therefore details will not be given thereof.

The command unit 12 is used to operate an accessory or attachment, such as a front loader (not shown) which can be attached to the tractor (not shown). By tilting the joystick 14 it is possible to raise or lower a rocker (not shown) of the front loader and to adjust a manure gripper (not shown) arranged on the rocker. The push button keys 16a and 16b and the rocker switch 18 permit additional vehicle functions to be operated, such as opening and closing of the manure gripper.

According to one possible development of the control system 10, the driver can pre-define favorite keys for the vehicle functions which are to be operated by the push button keys 16a and 16b. In this way, frequently required vehicle functions can be called directly when necessary.

Furthermore, the push button keys 16a and 16b are located within a display field or area 20. This display field 20 has a corresponding plurality of separate display devices 22a and 22b which are embodied as film-like, preferably flexible, display elements. Each of the display elements 22a and 22b includes an optical layer which can be activated and which is arranged between an upper and a lower electrode layer and has a multiplicity of liquid crystal bubbles which are integrated into a polymer matrix and have a diameter of 0.1 μm to 40 μm. The polymer matrix is composed of polymerized monomers with a layer thickness of 5 μm to 40 μm. The liquid crystals are oriented in an electrical field which is generated between the upper and lower electric layers by applying a corresponding control voltage. The optical layer is embodied so that it has regions which permit figurative and/or alphanumeric display contents to be displayed. The film-like display elements 22a and 22b are attached to the slightly curved upper side of the joystick 14 and bonded thereto by means of a rear-side adhesive surface.

The command unit 12 is a component of a modular operating concept of the tractor, and can therefore be retrofitted, or when necessary replaced with another operating element, in order to expand or adapt the functional scope. To this extent, the illustration of the command unit 12 is merely exemplary.

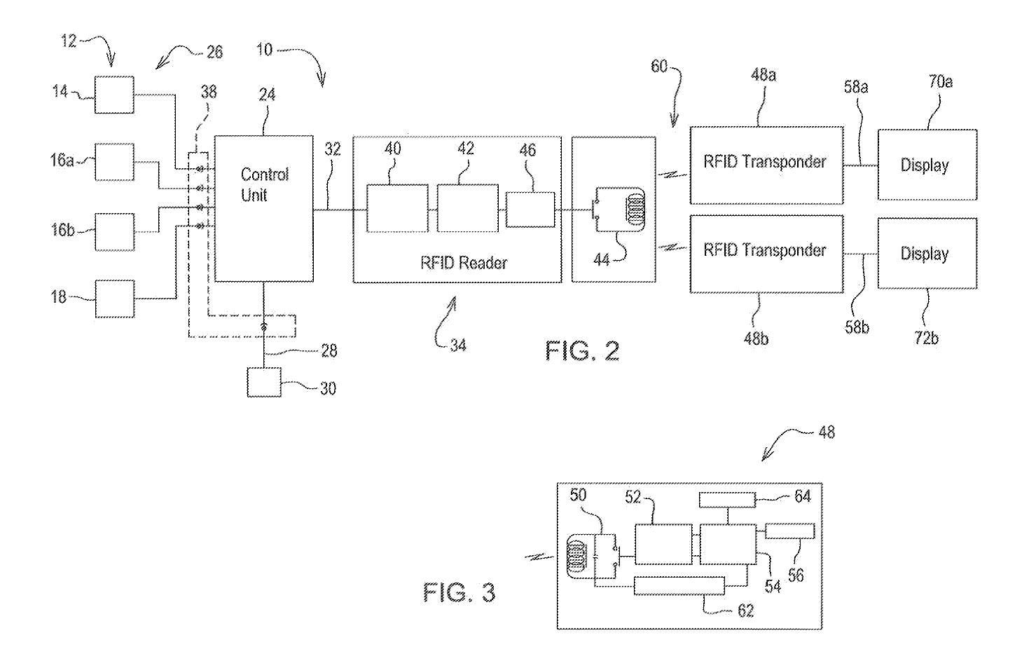

Referring now to FIG. 2, the components which correspond to or are comparable in terms of their function are characterized by the same reference symbol as in FIG. 1. The central component of the control system 10 is a microprocessor-controlled control unit 24. The control unit 24 is connected, on the one hand, via data lines 26 to the primary and secondary command units 14, 16a and 16b and 18 of the command unit 12 and, on the other hand, via a data line 28 to a sensor unit 30 for determining an operationally occurring vehicle state. The sensor unit 30 is, for example, a force sensor which senses loading of the front loader (not shown).

The control unit 24 is connected via a data line 32 to an RFID reading unit 34 located in the tractor. The control unit 24 is connected to the command unit 12 here by a plug-type connector 38 which is arranged on the underside of a base housing 36 of the command unit 12. Alternatively, the RFID reading unit 34 is accommodated in the basic housing 36 of the command unit 12, wherein the RFID reading unit communicates via the plug-type connector 38 and via the data line 32 to the control unit 24 which is located in the tractor. The data line 32 may be a CAN data bus which is fixedly routed in the tractor.

The RFID reading unit 34 includes an input interface 40 for communicating with the control unit 24 and a data processing unit 42 for actuating an analog radio frequency circuit 46 which interacts with an antenna coil 44.

Referring now to FIGS. 2 and 3, the system includes a plurality of RFID transponders, with two such units, 48a and 48b being shown in FIG. 2. Each RFID transponder 48a, 48b interacts with one of a corresponding plurality of display devices 72a and 72b. As best seen in FIG. 3, each RFID transponder 48a, b has a corresponding antenna 50 in the form of a coil, an analog high frequency circuit 52 and a data processing unit 54 for calling display contents which are stored in a data memory 56 and are to be displayed on the display device 72a and 72b. By way of example, each of the two display devices 72a and 72b is connected to a separate RFID transponder 48a, by separate data lines 58a, b.

In order to establish a data exchange connection to the RFID transponder 48a, b, the RFID reading unit 34 generates an electromagnetic field 60, which is received by the antenna coil 50a, b of the RFID transponder 48a, b. As a result, the data memory 56a, b which is contained in the RFID transponder 48a, b is activated, with the result that encoded instructions can be read out and in by means of the RFID reading unit 34 via the antenna 50a, b.

The RFID transponder 48a, b is structurally integrated as an organic (polymer) CMOS circuit into the polymer matrix of the display device 72a and 72b which is embodied as a film-like display element. The antenna 50a, b is printed on in the form of a helix in the region of the rear side of the display device 72a and 72b.

Each display device 72a and 72b is supplied with electrical energy by the corresponding RFID transponder 48a, b, so that a separate electrical energy source can be dispensed with. The RFID transponder 48a, b is of passive design, i.e. it acquires the electrical energy necessary for operation from an induction current generated in the antenna coil 50a, b. The induction current is generated by irradiating the antenna coil 50a, b by means of the electromagnetic field 60 of the RFID reading unit 34. The induction current which is generated is conditioned in a rectifier unit 62a, b for operating the RFID transponder 48a, b and the display device 72a and 72b connected thereto.

Each of the display contents stored in the data memory 56a, b is unambiguously assigned an identification feature, in the form of a numeric code, which can be selected by means of the RFID reading unit 34. By selecting a certain identification feature, the associated display content is called from the data memory 56a, b and subsequently fed to a display driver 64a, b for the purpose of displaying on the display device 72a and 72b.

In other words, the control unit 24 determines an identification feature, in the form of an associated numeric code, which is assigned to the activation of the command unit 12 and/or the vehicle state determined the force sensor 30. This numeric code is transmitted wirelessly as an encoded instruction by the RFID reading unit 34 to the RFID transponder 48a, b which is assigned to the display device 72a and 72b. The RFID transponder 48a, b checks whether a display content which corresponds to the read-in numeric code is stored in the data memory 56a, b. If this is the case, the respective display content is displayed on the display device 72a and 72b by suitably actuating the display driver 64a, b.

The display contents may include graphical and/or textual information relating to the current operating position of an attachment to the vehicle. Information about inadmissible loading of the attachment, which is detected by the force sensor 30, is displayed with warning text or a warning pictogram.

The control system 10 also provides for an automatic configuration process to be carried out during which, after the initiation of the control system 10 (for example, when the tractor starts), the control unit 24 sequentially reads out the available display contents from the data memories 56a, b of the RFID transponders 48a, b by means of the RFID reading unit 34, and adapts the operating scope or display scope of the control system 10 in accordance with the display contents stored in the data memories 56a, b. This is advantageous in particular in the case of modular operating concepts to implement a plug-and-play function in which, as in the present exemplary embodiment, functional extension or functional modification is provided by adding or exchanging command units.

The display contents which are stored in the data memory 56a, b may be a component of a menu-based user interface for operating a multiplicity of vehicle functions. Such user interfaces include a hierarchically organized menu structure with a plurality of operating levels, wherein each of the operating levels comprises one or more menu entries corresponding to associated vehicle functions and/or operationally occurring vehicle states to be operated. After a specific menu level has been called, all the menu entries included therein, or else only a number of selected menu entries, may be displayed on the display device 72a and 72b.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

1-13. (canceled)

14. A control system for a motor vehicle, the control system comprising:
a command unit for operating an associated vehicle function;
a sensor unit which senses a vehicle parameter;
a plurality of display devices;
a control unit connected to the sensor unit to the command unit;
an RFID reading unit connected to the control unit; and
a plurality of RFID transponders, each connected to a corresponding one of the display devices, each RFID transponder including a data memory for storing display content, the control unit actuating each display device by transmitting signals between the RFID reading unit and the RFID transponder, and the RFID transponder causing the data memory to communicate to one of the display devices display content associated with the sensed vehicle parameter
in response to activation of the command unit and/or to the sensed vehicle parameter.

15. The control system of claim 14, wherein:
a plurality of display contents are stored in the data memory in accordance with a plurality of different vehicle functions and/or a plurality of vehicle parameters.

16. The control system of claim 14, wherein:
the control unit performs a self-activated configuration process for adapting an operating scope and/or a display scope of the control system in accordance with the display contents stored in the data memory.

17. The control system of claim 14, wherein:
the command unit operates a plurality of vehicle functions.

18. The control system of claim 14, wherein:
each display device is supplied with electrical energy by means of a corresponding one of the RFID transponders, and each RFID transponder is passive.

19. The control system of claim 14, wherein:
a display element is positioned on the command unit.
